(19) United States
(12) Patent Application Publication
(10) Pub. No.: US 2003/0234279 A1
(43) Pub. Date: Dec. 25, 2003

(54) Exit side strip pusher mechanism for a flash butt welder

(75) Inventors: David C. Gollan, Vienna, OH (US); Paul A Satolli, Warren, OH (US); Barry L. Shultz, Hubbard, OH (US)

Correspondence Address: Thomas E. Kocovsky, Jr., FAY, SHARPE, FAGAN, MINNICH & McKEE, LLP, Seventh Floor, 1100 Superior Avenue, Cleveland, OH, 44114-2518, US

(73) Assignee: TAYLOR-WINFIELD CORPORATION

(21) Appl. No.: 10/174,660

(22) Filed: Jun. 19, 2002

(51) Int. Cl. B23K 31/02

(52) U.S. Cl. 228/212

(57) ABSTRACT

An exit side pusher mechanism (10) for a flash butt welder (14) applies a pushing force which opposes the tendency of an leading strip (16) of steel to back away from a spacer bar (40) prior to welding. The pusher mechanism includes a rotating drive wheel (82) which frictionally engages the strip. The drive wheel is lowered into an engagement position by a pneumatically driven actuator (100). A pneumatically driven drive motor (84) rotates the drive wheel a preselected distance to advance the strip back towards the spacer bar.

### BACKGROUND OF THE INVENTION

The present invention relates to the field of steel coil processing. It finds particular application in conjunction with a pusher mechanism for use with a flash butt welder, and will be described with particular reference thereto. It should be appreciated, however, that the invention is also applicable to movement of other sheet products through a processing system.

Steel strip products are typically manufactured from steel slabs known as billets. A billet is heated and hot-rolled to produce relatively thick strips of steel which are subsequently further processed. The strip manufacturing operations which are performed subsequent to hot-rolling utilize relatively long steel strips. The strips formed in the hot-rolling operation are typically end-welded together to provide strips of sufficient length for relatively continuous and efficient operations, such as pickling and cold-rolling.

The welds which connect hot-rolled strips together ideally are virtually indistinguishable from the metal in the strips themselves so that the weld material can form a part of a finished product made from strip steel. In addition, and perhaps of more importance, welds are preferably sufficiently flexible and durable to permit subsequent strip forming operations to be performed without weld failure.

During a strip welding operation, the strips formed by hot-rolling are passed through a shearing apparatus which cuts off irregular material from each end of each strip. The amount of material cut off is sufficient to provide uniform strip ends. A flash welder is then used to weld adjacent ends of each coil together, to form a longer strip. The longer welded strips thus formed are processable at a faster rate than if the shorter strips were processed separately.

A commonly used welding tool for joining adjacent strips end-to-end is known as a flash butt welder. A spacer plate or bar is positioned in the gap between two pairs of conductive and relatively movable platens. The spacer plate is adjusted for the thickness of the strips being welded. The respective adjacent ends of the strips to be welded together are centered and moved against the spacer plate. Pairs of welding dies associated with the platens are then clamped on the strip. The pairs of dies are separated slightly from each other to allow the spacer plate to be withdrawn. The end portions of the steel strips are then moved toward each other, and subjected to flashing and upsetting steps, during which an electric current is passed between the strip ends to heat the metal and thereby effect the weld.

In the flashing step, the adjacent strip ends are progressively moved toward each other over a predetermined travel distance of about 1 to 2 centimeters, by relative motion of the platens, accomplished by use of a hydraulic motive system. An electrical voltage is applied between the ends through the conductive platens. When the ends have moved sufficiently close to contact each other, this voltage causes an electric current to flow between the strip ends. As the strips move together, the electrical shorts generate a temperature high enough to melt the material for fusing.

After the flashing step, the weld is completed by forcing the molten ends together under heavy pressure with the hydraulic system in the upsetting step, while continuing the application of the electrical potential. The upsetting force unites the molten metal at the adjacent ends, and also displaces undesirable slag, or oxidized material, which may be present.

After the weld is completed by the upsetting step, the excess metal is trimmed off, ideally leaving a relatively smooth and uniform area of joinder between the strips.

One problem which arises is that the end of the leading exiting strip of steel, generally known as the “tail,” at the downstream side of the welder has a tendency to back away from the spacer bar during the centering process. The pushing force which moves the strip end towards the spacer bar is generated by an exit looper roll, positioned at a far end of a transfer table, which is raised to create a loop in the steel. Clamps holding the exiting sheet to the transfer table are then released and the sheet steel loop forces the trailing end of sheet towards the spacer bar. Because of the distance between the exit looper roll and the spacer bar, it can take some time for a new loop to be created and provide the pushing force to the end of the strip to be welded if the strip backs away from the spacer bar. This results in wastage of time as the strip is recentered and repositioned or, if not observed, leads to inadequate welding. The down-time caused by a strip break is often on the order of several hours. Additionally, a roller which becomes scored by the exposed ends often has to be reground to restore its original surface and shape, or in the worst case, replaced, at considerable cost.

The present invention provides a new and improved apparatus and method of use which overcomes the above-referenced problems and others.

### SUMMARY OF THE INVENTION

In accordance with one aspect of the present invention, a welding system is provided. The system includes a means for welding a trailing end of a first metal strip to a leading end of a second metal strip. A means is provided for moving the first strip in a first direction through the welding means. A pusher mechanism pushes the first metal strip in a second direction generally opposite to the first direction to urge the trailing end of the first strip toward a correct position for welding. The pusher mechanism includes a means for applying a force to the first metal strip in the second direction, and a means for moving the force applying means between a first position, in which the force applying means is spaced from the first strip, and a second position, in which the force applying means engages the first strip.

In accordance with another aspect of the present invention, a method of welding is provided. The method includes selectively positioning a spacer bar near an end of a first metal strip and moving the strip until it is adjacent the spacer bar. A drive wheel is moved from a first position, away from the metal strip, to a second position, in which the drive wheel frictionally engages the strip. The drive wheel is rotated to apply a pushing force to the strip to prevent the strip from backing away from the spacer bar. The trailing end is welded to a leading end of a second strip.

One advantage of the present invention is that the leading steel strip is prevented from backing away from the spacer bar.

Another advantage resides in assured weld consistency.

Another advantage of the present invention is that the occurrence of weld breaks is reduced.

Still further advantages of the present invention will become apparent to those of ordinary skill in the art upon reading and understanding the following detailed description of the preferred embodiments.

### BRIEF DESCRIPTION OF THE DRAWINGS

The invention may take form in various components and arrangements of components, and in various steps and arrangements of steps. The drawings are only for purposes of illustrating a preferred embodiment and are not to be construed as limiting the invention.

FIG. 1 is a perspective view of an exit side strip pusher mechanism, according to the present invention;

FIG. 2 is a side sectional view of the exit side strip pusher mechanism of FIG. 1 attached to the exit side of a flash butt welder;

FIG. 3 is a side sectional view of a flash butt welder showing the location of the exit side strip pusher mechanism of FIG. 1;

FIG. 4 is a top view, in partial section, of the flash butt welder of FIG. 3, without the strip pusher mechanism;

FIG. 5 is a front view of the exit side strip pusher mechanism of FIG. 1 positioned above the support roll.

### DETAILED DESCRIPTION OF THE PREFERRED EMBODIMENTS

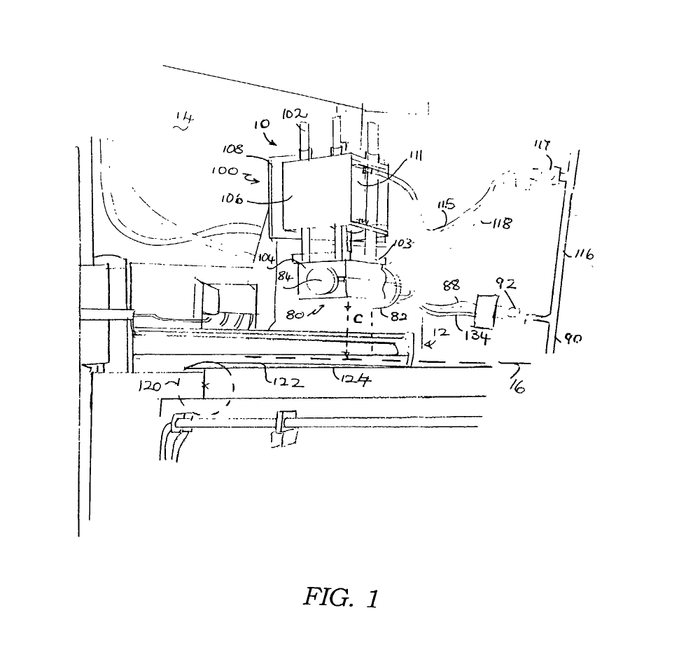

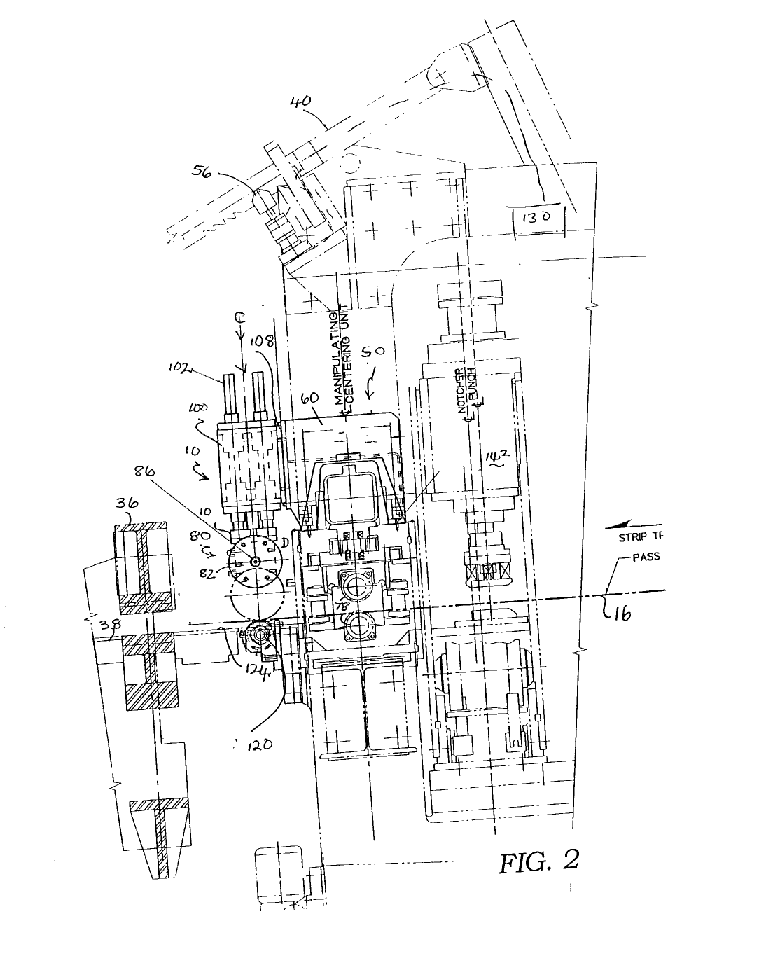

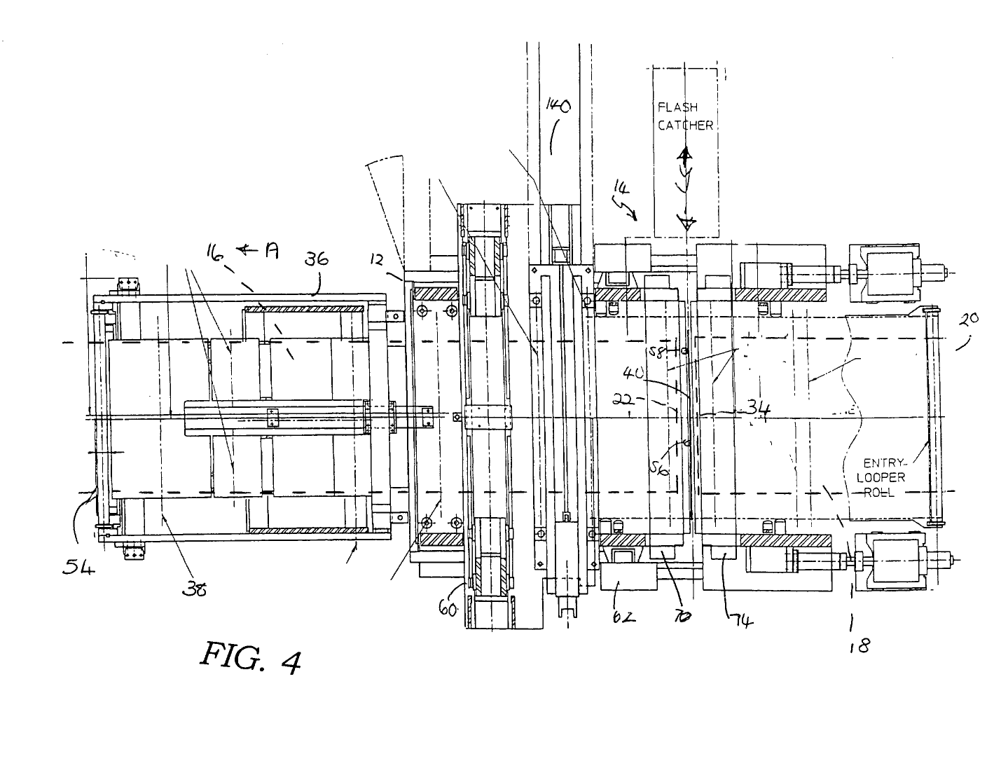

With reference to FIGS. 1 and 2, an exit side strip pusher mechanism 10 is mounted adjacent the exit side 12 of a welding apparatus 14, which is a flash butt welder in the preferred embodiment. The pusher mechanism 10 selectively applies a pushing force to a leading strip or “tail” 16 of steel, or other metal to be welded, to ensure correct positioning of the strip prior to welding, as is described in greater detail below. The strip is preferably in the form of a sheet of between about 1 mm and 6 mm in thickness and about 40 cm to about to 2 meters in width, although it is also contemplated that the pusher mechanism be used with bars of steel of considerably greater thickness but lesser width. It is also contemplated that an entering pusher mechanism (not shown), analogous to the exiting pusher mechanism 10, is provided to provide a selective pushing force on an entering or trailing strip or “head” 18 (FIG. 4) of steel.

As will be understood, the term “flash welding” is used to designate the method of welding wherein the adjacent edges of two workpieces to be welded are accurately positioned in closely adjacent but spaced parallel relation with respect to each other. The workpieces are then moved relatively toward each other while electrical potential is applied thereto to cause an arc or flashing between the adjacent edges of work pieces to soften them. The edges of the workpieces are then caused to butt under considerable pressure and high amperage current flows across the butting edges to fuse and weld them together.

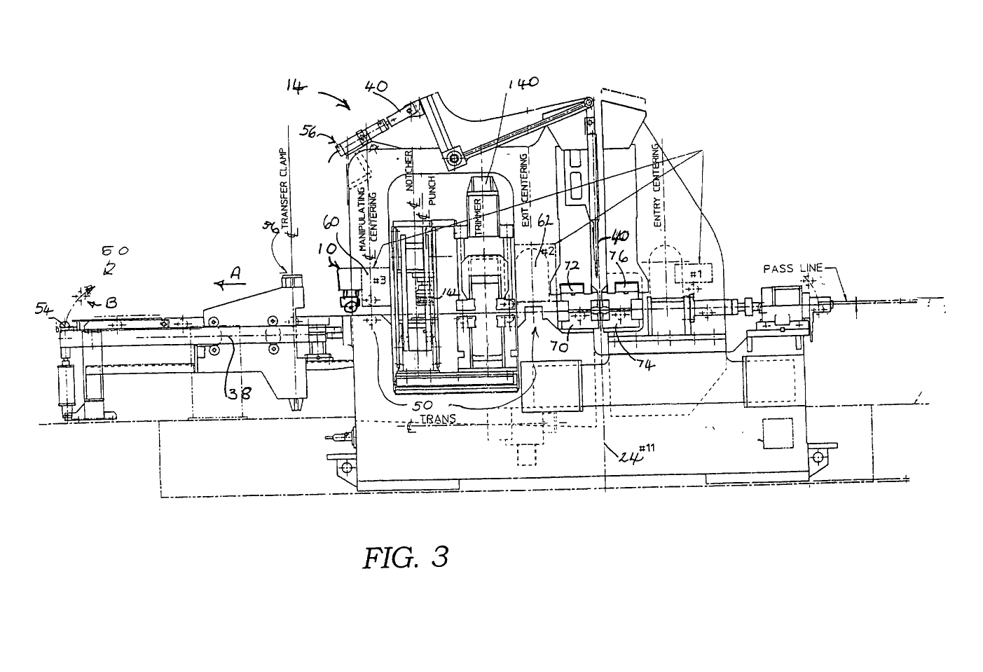

With reference also to FIGS. 3 and 4, the flash butt welder 14 takes coils of sheet metal, such as sheet carbon steel, and welds them end-to-end, forming a large coil from perhaps five smaller coils. Each coil is typically between about 50 and 150 centimeters in width, and weighs 5,000-10,000 Kg. A first uncoiled strip 16 (shown in phantom in FIG. 4) of steel enters the welder 14 from an entry side or upstream end 20 of the welder. The strip 16 is carried through the welder machine until its tail end 22 is positioned about 30-40 cm to the right of a weld line gap 24, where the weld is to be formed. The strip 16 is referred to as the leading strip or tail, since its forward end is positioned downstream of the weld during welding. Prior to reaching this position, the tail end 22 of the leading sheet 16 is sheared by a shearer (not shown) to provide a straight edge for welding. The shearer removes several centimeters of material from the ends of each coil, before welding, to eliminate rough and irregular ends, to expose regular ends of homogeneously good strip material for welding together.

As the tail 16 proceeds to the weld line, the next or trailing sheet 18, which is referred to as the entering sheet or head (FIG. 4), is fed in from the entry side 20 of the flash butt welder, with its leading end 34 sheared, and is positioned to the right (i.e., upstream) of the weld line gap 24 (FIG. 3). The forward end of the tail 16 is gripped by transfer clamps 36 (FIG. 2). The clamps 36 are mounted adjacent a transfer table 38, which receives the strip 16 from the exit end 12 (FIG. 4) of the flash butt welder. The clamps 36 move alongside the transfer table 38, pulling the tail end of the tail 16 through the welder. When both strips are approximately positioned adjacent the weld line, a spacer bar 40 (FIG. 3) is moved into a position between the two ends 22, 34 (FIG. 4).

As shown in FIG. 3, a strip moving mechanism 50 applies the primary pushing force on the tail 16 to form an exit loop. The strip moving mechanism 50 preferably includes an exit looper roll 54 mounted at the downstream end of the transfer table 38, beyond the clamps 36. While the transfer clamps 36 are traveling downstream, in the downstream direction of arrow A, the exit looper roll 54 is raised above the table 38 to a position B, shown in phantom in FIG. 3. This creates a loop in the tail. This loop is later used to push the tail back towards the weld line gap 24. Specifically, once the tail end 22 (FIG. 4) of the tail is positioned downstream of the weld gap 24, the clamps 36 are released to release the leading steel sheet 16 (FIG. 2) from the transfer table 38. The looper roll 54 is lowered and the loop created by the looper roll acts as a spring to push the sheet 16 back towards the spacer bar 40. Although a looper roll 54 is an effective strip moving mechanism, other strip moving mechanisms known in the art for moving the tail back toward the weld line are also contemplated.

Sensors 56, 58 (FIG. 4) on the spacer bar 40 register when the end 22 of the tail is properly abutting the bar 40. During or following this process, alignment means, such as centering units 60, 62 (FIG. 3) typically, a manipulating centering unit 60 and an exit centering unit 62, ensure that the tail 16 (FIG. 2) is properly aligned or “centered” as it moves back towards the spacer bar 40. This is done by moving the end of the tail 16 horizontally a short distance in a direction perpendicular to the normal direction of travel of the sheet (i.e., in the direction of arrows Y in FIG. 4).

Once correctly aligned, one of the adjacent ends 22, 34 (FIG. 4) is clamped onto a stationary conductive platen 70 by a first pair of welding die assemblies 72 (FIG. 3), and the other is clamped to a movable conductive platen 74 by a second pair of welding die assemblies 76 (FIG. 3).

When the tail 16 (FIG. 2) has been pushed back towards the spacer bar 40 (FIG. 3) by the force created by the loop, or shortly before then, the pusher mechanism 10 is actuated. The pusher mechanism 10 exerts a pushing force on the tail 16 in the direction of the weld gap. In the event that the tail 16 starts to back off, for example, during the alignment process, this force ensures that the strip end 22 is pushed firmly back against the spacer bar 40. Since the strip moving mechanism 50 provides the primary pushing force to the tail 16, the pusher mechanism 10 need only apply a limited pushing force sufficient to prevent the tail 16 from backing off after the strip moving mechanism 50 has positioned the leading strip firmly against the spacer bar 40.

As shown in FIGS. 1-2 and 5, the pusher mechanism 10, is mounted, for example, to a part of the exit side 12 of the flash butt welder, for example, the manipulating centering unit 60, which is the part of the welder generally furthest from the weld gap (FIG. 3).

The pusher mechanism 10 thus serves to push the leading strip back towards the spacer bar 40 prior to welding. As shown in FIG. 2, the pusher mechanism is positioned to direct the leading sheet back through a pair of exit rollers 78, which form a part of the manipulating centering unit 60 of the flash butt welder, through which the leading sheet travels on its way to the transfer table 38. The pusher mechanism 10 thus remains in a fixed position, relative to the direction of travel A of the strip 16, and does not move in either direction A or in an opposite direction to direction A to effect pushing. The pusher mechanism 10 is preferably positioned closer to the weld line than the looper roll 54 (FIG. 3), i.e., between the looper roll and the spacer bar 40.

As shown in FIGS. 1, 2, and 5, the pusher mechanism 10 includes means 80 for applying a force to the leading sheet in the direction of the weld line (i.e., in an upstream direction, opposite to arrow A). In a preferred embodiment, the means for applying a force includes a drive wheel 82 which is rotated or otherwise actuated by a pneumatic drive motor or other rotary actuator 84. The drive wheel 82 frictionally engages the leading sheet 16. The drive wheel 82 is formed from rubber or other suitable material for providing a good grip on the surface of the sheet 16. The wheel 82 is aligned with its rotational axis R perpendicular to the direction of travel A of the sheet. The drive motor 84 preferably rotates the drive wheel though a preselected rotation angle about axis R. The angle is pre-adjustable, e.g., for applying different amounts of force, depending on the weight of steel to be pushed. The drive motor 84 is advantageously a pneumatically driven motor, which is powered by air and maintains full torques even when stalled. A horizontal drive shaft 86 connects the drive motor to the drive wheel 82 and transfers the rotational force to the drive wheel. The air is supplied to the motor via a hose 88, connected with a source of compressed air by a supply line 90. The air pressure within the hose 88 is controlled by a valve and regulator assembly 92. Because the drive motor is operating in tandem with the forces supplied by the loop, only a small amount of torque needs to be generated to push the sheet back against the spacer bar.

When not in use, the drive wheel 82 is positioned a short distance away from the leading steel sheet 16, such as about 6-10 cm above it, so that the wheel does not interfere with the downstream movement of the sheet through the welder. When it is time for the pusher mechanism 10 to push the sheet, the drive wheel 82 is brought into position on the leading sheet by a vertical actuator 100, such as a vertical travel pneumatic slide, although other actuating means are also contemplated (for example, the drive wheel may be pivoted into position rather than being vertically lowered). As illustrated in FIG. 2, the actuator 100 moves the drive wheel 82 in the direction of arrow C from an upper position D, to a lower position E, shown in phantom. Once the wheel 82 is in a position in which it frictionally engages the sheet 16, the rotary actuator 84 is actuated to apply a pushing force to push the sheet in the upstream direction. After the pushing is completed, the wheel 82 is retracted back to position D.

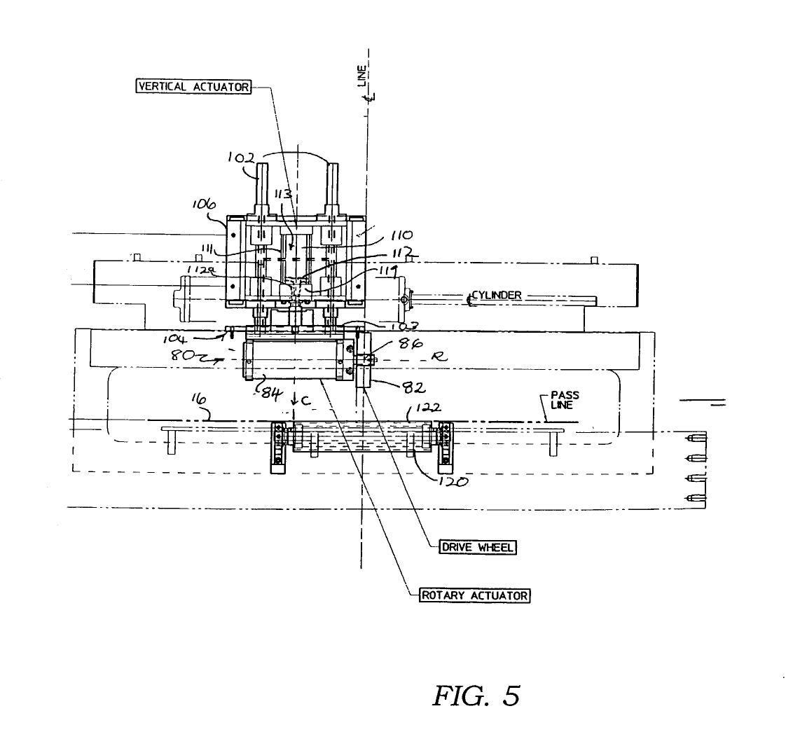

In a preferred embodiment, the vertical actuator 100 includes guide rods 102 (four in the illustrated embodiment), which are connected adjacent their lower ends to a base plate 103. The base plate forms an upper surface of a support housing or bracket 104 for carrying the drive motor 84. The guide rods 102 are slidably received in an actuator housing 106, for vertical travel relative thereto. The actuator housing is rigidly mounted by a suitable bracket 108 to the downstream end of the manipulating centering unit 60. An actuator mechanism 110, carried by the actuator housing 106, drives the guide rods vertically, in tandem. The actuator mechanism 110 is preferably a piston, with a non-movable part or cylinder 111 supported by the actuator housing 106 and a movable part 112 which is connected by a piston rod 112a connected to the base plate 103 (FIG. 5). An upper chamber 113 is defined within the cylinder, above the piston 112, which is fed with air to move the piston downward. The air is supplied to the upper chamber of the actuator mechanism 110 via a hose 115, connected with the source of compressed air by a supply line 116. The air pressure within the hose 115 is controlled by a valve and regulator assembly 117 (FIG. 1). A second hose 118 is connected with a lower chamber 119 of the cylinder and is fed with air when it is time to retract the piston 112 and hence raise the drive wheel 82.

The pneumatically driven vertical actuator 100 is effective to retain the drive wheel 82 in firm contact with the sheet 16 and yet absorbs any jarring movements of the sheet as it moves upstream.

It will be appreciated that other force applying means 80 may alternatively be used. For example the drive wheel 82 could be replaced by a block which is moved vertically downward by a similar vertical actuator to actuator 100 until a generally flat lower surface is in contact with the leading sheet 16. The block is then pushed horizontally, for example, by a horizontally aligned pneumatically driven piston, similar to the piston 110, to push the sheet back towards the spacer bar 40.

A support means, such as a support roll 120 or support plate (not shown) supports the lower side of the sheet 16 during the pushing step and is located on the opposite side of the sheet to the pusher mechanism 10. The support means provides a support surface 122 which is maintained in a fixed vertical position, at least during the pushing step, to keep the sheet 16 in contact with the drive wheel 82. If a plate is used, the plate may have a curved surface or tapered edges so that the leading sheet 16 slides over the plate during pushing. The plate is optionally integral with or a part of an upper surface 124 of the transfer table.

Preferably, the support means includes a support roll 120 having a rotational axis which is aligned generally parallel with and directly beneath that of the drive wheel. The support roll is advantageously mounted for rotation to the transfer table at or adjacent an upstream end thereof. The support roll is preferably formed from a rigid material, such as steel, and supports the underside of the leading steel sheet 16. The support roll rotates as the leading steel sheet moves over it, in both the upstream and downstream directions.

It will be appreciated that the positions of the pusher mechanism 10 and the support means 120 could alternatively be reversed. In this alternate embodiment, the pusher mechanism is located below the leading sheet 16 and pushes the drive wheel 82 upwardly from below. The support means is located above the sheet and acts to keep the sheet in contact with the drive wheel.

With reference once more to FIGS. 1-2 and 6, in the preferred embodiment, operation proceeds as follows. As the vertical actuator 100 moves the drive wheel 82 downwards, the steel sheet 16 is gripped between the drive wheel and the support roll 120. The drive motor 84 then rotates the drive wheel through a preselected rotational angle that applies a pushing force on the leading strip in the direction of the spacer bar and drives the leading strip back towards the spacer bar 40 in the event that the leading strip starts to back off. The support roll 120 turns if the sheet is driven back into the butt welder by the drive wheel.

During the pushing operation, the spacer bar sensors 56, 58 detect the position of the strip end 22 or, alternatively, detect whether the strip end is in a preselected position abutting the spacer bar. Preferably, there are two (or more) sensors, one adjacent each of opposite sides of the strip. The sensors 56, 58 are preferably contact sensors, such as pressure sensors, which detect the presence of the strip from pressure exerted on the sensors by the strip 16, or which complete an electrical circuit through contact with the strip. Alternatively, the sensors are infrared or other radiation sensors capable of detecting either the distance of the strip end from the sensor or whether the strip end is at a selected position or within a selected position range.

The sensors 56, 58 are electrically connected with a control system 130 (FIG. 2), which registers the position of the strip from signals sent by the sensors (or absence of correct positioning), and signals the manipulating centering unit 60 accordingly. The manipulating centering unit moves the strip 16 in the direction of the sensor that is not in contact with the strip tail end 22.

In one embodiment, the pusher mechanism 10 is actuated automatically, at a selected point in the cycle, irrespective of whether the sensors 56, 58 detect backing off or other incorrect placement of the tail end 22. Because the motor 84 is pneumatically driven, it will stall out when the force extended by the spacer bar 40 on the strip 16 reaches a predetermined level.

In another embodiment, the control system 130 signals the pusher mechanism to operate only when the sensors 56, 58 detect that the strip has backed away or has not reached its correct position.

When both of the spacer bar sensors 56, 58 are in contact with the strip end 22 or otherwise indicating correct alignment of the strip end, the exit clamps 72 secure the strip for welding. Once the exit strip end 22 has been clamped by the exit clamps, there is no further requirement for the pusher mechanism 10. The vertical actuator 100 is operated to raise the drive wheel 82 upward, away from the leading sheet, and the rotary motor 84 then moves back to its start position. For example, air is supplied through a hose 134 (FIG. 1) to cause the drive wheel 82 to rotate a selected angular distance back to its start position.

The transfer clamp 36 then moves in the upstream direction back to its original position, adjacent the upstream end of the transfer table, ready for moving the completed weld to a trimmer 140 position (FIG. 3).

Welding of the ends then proceeds in a conventional manner. Specifically, the welder 14 (FIG. 3) flash butt welds the adjacent ends 22, 34 together in accordance with a flashing step and a subsequent upset step. In the flashing step, the movable platen 74 is actuated by a hydraulic or other movement system (not shown) connected thereto to move the movable platen 74 towards the stationary platen 70. In this way, the adjacent ends of the steel sheets are moved relatively towards each other. Simultaneously, an electrical voltage of about 400 kVA is applied between the adjacent strip ends 22, 34 to heat the regions of the ends, and render the metal molten to facilitate fusing. The arcing of electric current between the ends 22, 34 continues at an increasing rate (constant rate in some welders) as the ends are advanced progressively closer together by motion of the platen 74.

When the movable platen 74 has advanced the ends 22, 34 of the sheets to within a predetermined distance of one another, the upsetting step takes place, in which the platen 74 forces the ends together under heavy pressure, while the application of electric power between the conductive platens and the ends continues for a time. The hydraulic system produces a signal when the ends have moved to within a predetermined distance of each other, indicating the end of flashing and the beginning of the upset step.

The welded portion of the coil is moved to the trimmer 140 (FIG. 3) where excess weld material is removed. The strip may also pass through a notcher punch 142 (FIG. 2), which creates a notch if the sheet width is to be changed. The entering strip 18 (FIG. 4), once welded, becomes the leading strip and the entire process is repeated several more times until a coil of a selected number of strips is created.

The joined sheets of strip material are then subjected to further processing, such as cold reduction, and recoiled by a coiling apparatus (not shown) into large coils, which may undergo further processing, such as annealing and tempering.

The invention has been described with reference to the preferred embodiment. Obviously, modifications and alterations will occur to others upon reading and understanding the preceding detailed description. It is intended that the invention be construed as including all such modifications and alterations insofar as they come within the scope of the appended claims or the equivalents thereof.

Having thus described the preferred embodiment, the invention is now claimed to be:

1. A welding system comprising:
a means for welding a trailing end of a first metal strip to a leading end of a second metal strip;
a means for moving the first strip in a first direction through the welding means; and
a pusher mechanism for pushing the first metal strip in a second direction generally opposite to the first direction to urge the trailing end of the first strip toward a correct position for welding, the pusher mechanism including:
a means for applying a force to the first metal strip in the second direction, and
a means for moving the force applying means between a first position, in which the force applying means is spaced from the first strip, and a second position, in which the force applying means engages the first strip.

2. The welding system of claim 1, wherein the welding means includes:
a flash butt welder.

3. The welding system of claim 2, further including:
a strip moving mechanism which moves the first strip in the second direction until it is adjacent to a spacer bar, the pusher mechanism urging the first strip against the spacer bar after the strip moving mechanism has moved the first strip in the second direction.

4. The welding system of claim 3, wherein the strip moving mechanism includes:
a looper roll which forms a loop in the first strip, which loop biases the trailing edge toward the spacer bar.

5. The welding system of claim 1, wherein the means for moving the first strip in a first direction includes:
a transfer clamp which clamps the strip and moves the strip in the first direction away from the welding means.

6. The welding system of claim 1, wherein the force applying means includes:
a drive wheel which rotatably engages the first strip.

7. The welding system of claim 6, wherein the means for applying a force further includes a motor which applies a rotational force to the drive wheel.

8. The welding system of claim 7, wherein the motor is pneumatically driven.

9. The welding system of claim 6, wherein the means for moving the force applying means includes:
a vertical actuator which moves the drive wheel vertically between the first position, above the strip, and the second position, in which the drive wheel engages the strip.

10. The welding system of claim 9, wherein the vertical actuator includes a pneumatically driven piston which operates on the drive wheel to move it vertically.

11. The welding system of claim 10, wherein the piston is movably mounted to a housing and is driven vertically with respect to a housing.

12. The welding system of claim 8, wherein the housing is mounted to a portion of the welding means.

13. The welding system of claim 1, wherein the welding means includes:
a spacer bar which is selectively positionable between the ends of the strips such that the pusher mechanism pushes the first strip to maintain the trailing end in contact with the spacer bar.

14. The welding system of claim 13, wherein the welding means further includes:
at least one sensor which detects whether the trailing end of the first strip is abutting the spacer bar.

15. The welding system of claim 14, wherein the welding means further includes:
a controller which receives a signal from at least one sensor and instructs the pusher mechanism to push the strip towards the spacer bar.

16. A method of welding including:
(a) selectively positioning a spacer bar near a trailing end of a first metal strip;
(b) moving the first strip until it is adjacent the spacer bar;
(c) moving a drive wheel from a first position, away from the metal strip, to a second position, in which the drive wheel frictionally engages the first strip;
(d) rotating the wheel to apply a pushing force to the strip to prevent the first strip from backing away from the spacer bar; and
(e) welding the strip trailing end to a leading end of a second strip.

17. The method of claim 16, further including:
sensing whether the strip is abutting the spacer bar.

18. The method of claim 16, further including:
centering the end of the strip in a direction generally perpendicular to the direction of travel, so that the strip is aligned relative to a second strip to which it is to be welded.

19. The method of claim 16, further including, prior to the welding step:
moving the leading end of a second strip adjacent an opposite side of the bar; and
retracting the spacer bar.
